(19) United States
(12) Patent Application Publication
(10) Pub. No.: US 2009/0292461 A1
(43) Pub. Date: Nov. 26, 2009

(54) DYNAMIC DELIVERY OF WAYPOINT DATA ASSOCIATED WITH TRAVEL RESERVATIONS

(75) Inventors: Scott D. Mastie, Longmont, CO (US); John S. Anderson, Arvada, CO (US)

Correspondence Address: LAW FIRM OF DAN SHIFRIN, 6208 Devinney Circle, ARVADA, CO, 80004, US

(73) Assignee: IBM CORPORATION, Armonk, NY (US)

(21) Appl. No.: 12/123,614

(22) Filed: May 20, 2008

(51) Int. Cl. G01C 21/00

(52) U.S. Cl. 701/201

(57) ABSTRACT

Capabilities are added to a travel reservation system by delivering a traveler's destination information to a car reservation company computer for subsequent downloading as waypoint data into a global positioning system (GPS) device in the car being rented by the traveler. The traveler creates a travel itinerary, including a request for a rental car at a first destination and a second destination to which the traveler will drive the car. Information about the destinations is transmitted to the rental car company for downloading into a GPS receiver in the rental car for use by the traveler.

### TECHNICAL FIELD

The present invention relates generally to travel reservation systems and, in particular, to extending the services offered by a reservation system.

### BACKGROUND ART

Travel reservation software can provide a comprehensive one-stop shopping capability, allowing a traveler to make reservations for air, hotel and rental car through a single computer interface. Such systems often provide assistance in locating the closest major airport(s) which are nearby the traveler's destination. Some systems, such as the IBM “Online Travel Reservation” system, further extend the basic concept by adding layers of corporate policy to the user interface and purchasing process. Other interfaces may provide “packaged” or “bundled” deals which bring air, car and hotel reservations together into a single reservation. For example, such a system may allow a traveler to select a hotel from a pull-down list of hotels for a particular city. When renting an automobile, a map is usually available for the immediate area, usually the airport and major metropolitan area nearby. However, if renting a car and driving to another nearby state or area, the traveler may need other maps which are not in the rental car.

### SUMMARY OF THE INVENTION

The present invention provides further capabilities to a travel reservation system by delivering a traveler's destination information to a car reservation company computer for subsequent downloading as waypoint data into a global positioning system (GPS) device in the car being rented by the traveler. The traveler creates a travel itinerary, including a request for a rental car at a first destination and a second destination to which the traveler will drive the car. Information about the first and second destinations is transmitted to the rental car company for downloading into a GPS receiver in the rental car for use by the traveler.

### BRIEF DESCRIPTION OF THE DRAWINGS

FIG. 1 schematically illustrates a reservation system of the present invention;

FIG. 2 is a logical flow chart of a method of the present invention; and

FIG. 3 is an example of a user interface provided by a reservation system of the present invention.

### DETAILED DESCRIPTION OF THE PREFERRED EMBODIMENT

Some of the functional units described in this specification have been labeled as modules in order to more particularly emphasize their implementation independence. For example, a module may be implemented as a hardware circuit or in programmable hardware devices such as field programmable gate arrays, programmable array logic, programmable logic devices or the like. Modules may also be implemented in software for execution by various types of processors. An identified module of executable code may, for instance, comprise one or more physical or logical blocks of computer instructions which may, for instance, be organized as an object, procedure, or function. A module of executable code could be a single instruction, or many instructions, and may even be distributed over several different code segments, among different programs, and across several memory devices.

Furthermore, the described features, structures, or characteristics of the invention may be combined in any suitable manner in one or more embodiments. In the following description, numerous specific details are provided, such as examples of programming, software modules, hardware modules, hardware circuits, etc., to provide a thorough understanding of embodiments of the invention. One skilled in the relevant art will recognize, however, that the invention can be practiced without one or more of the specific details, or with other methods, components and so forth. In other instances, well-known structures, materials, or operations are not shown or described in detail to avoid obscuring aspects of the invention.

The logical flow chart depicts the general order of the labeled steps and is indicative of one embodiment of the presented process. Other steps and processes may be conceived that are equivalent in function, logic, or effect to one or more steps, or portions thereof, of the illustrated process. Additionally, the format and symbols employed are provided to explain the logical steps of the process and are understood not to limit the scope of the process. And, the order in which a particular process occurs may or may not strictly adhere to the order of the corresponding steps shown.

Many rental cars are now equipped with a Global Positioning System (GPS) device. As is known, a GPS device is able to accurately provide the current location of the unit as well as indicate the location of other selected locations. Thus, a GPS unit can help a traveler locate destinations such as a hotel and even provide appropriate driving directions to the desired destination. Unfortunately, GPS units offered by rental car companies must be manually programmed, which means that the traveler must enter information about the desired hotel, such as by looking it up in some manner by city, name, address or proximity. This is a time-consuming process at best, and at worst, can result in frustration, such as when the desired hotel is not in the unit's database or when the GPS unit directs the traveler to the incorrect hotel (e.g., the wrong Hilton hotel when there are more than one in a relatively small area). Similarly, a traveler may have a personal GPS device but have the same fundamental problems getting the appropriate destination waypoints programmed into the unit.

The present invention extends the usefulness of reservation systems and the convenience of using rental car GPS systems by passing destination information directly to the rental car company as part of the reservation process. Thus, a traveler can arrive at a destination city, pick up the car and find appropriate destinations from his or her itinerary, such as hotels and customers, already loaded into the GPS unit of the automobile which has been assigned to the traveler. In addition, the rental car company may include other value-added material, such as printed driving directions and improved maps, based on the destination data provided.

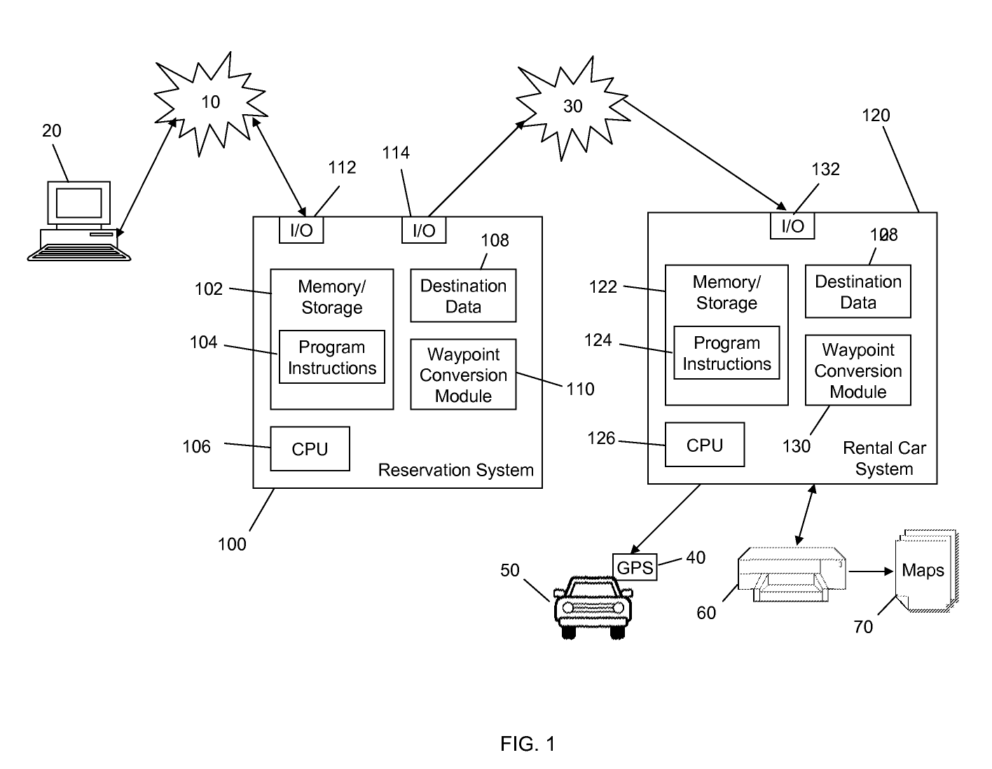

FIG. 1 schematically illustrates a reservation system 100 of the present invention. The system 100 includes a memory or other storage 102 for storing, among other items, computer program instructions 104 to be executed by a processor 106 in carrying out the process of the present invention. The reservation system 100 also includes memory or storage 108 for destination data and, optionally, a waypoint conversion module 110, both of which will be described below. The reservation system 100 further includes an interface 112 providing an interconnection with a network 10 through which a traveler using a personal computer 20 or comparable device can access the reservation system 100. The reservation system also includes a second interface 114 providing an interconnection with another network 30 through which reservations and travel information can be transmitted to travel vendors, including a rental car company system 120.

The rental car system 120 may be similar to the reservation system 100: it includes memory or other storage 122 for storing, among other items, computer program instructions 124 to be executed by a processor 126, memory or storage 128 for destination data and, optionally, a waypoint conversion module 130, an interface 132 providing an interconnection with the network 30.

It will be appreciated that the interfaces 112 and 114 may comprise a single interface. It will also be appreciated that the networks 10 and 30 may comprise a single network, such as the internet.

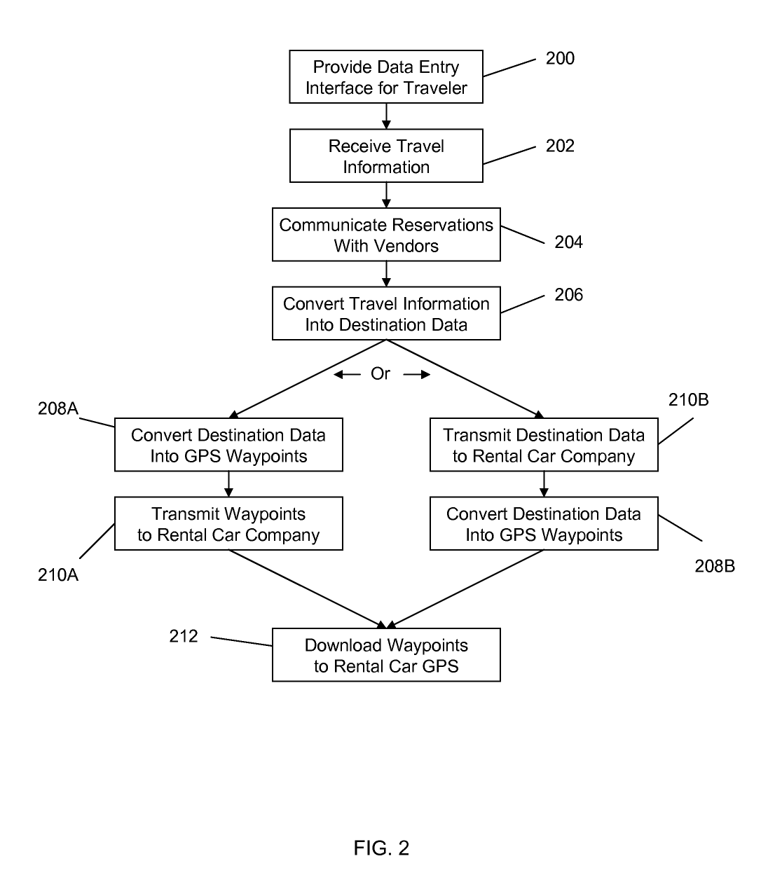

In one embodiment, as shown in the flow chart of FIG. 2, the traveler using the personal computer 20 logs onto the travel reservation system 100 through a user interface provided by the travel reservation system 100 (step 200) and chooses air travel to an airport nearby the final destination, a rental car to be reserved at or near the airport and a reservation at a hotel. After the choices are made, they are transmitted from the computer 20 to the travel reservation system 100 (step 202) which books the travel with the vendors offering the air, hotel and car (step 204). Each of these is an autonomous transaction; although there is a single record locator for the overall travel itinerary, there are also separate flight, hotel and car reservation numbers associated with those aspects of the overall itinerary. In accordance with the present invention, in addition to sending the rental car reservation to the rental car company, the system also converts the travel itinerary into destination data 108 (step 206), such as the name or address of a hotel for each night of the trip, to be transmitted to the rental car company system 120. The reservation system 100 may also capture data about a customer-input address which is to be visited, allowing the transmission of destination data 108 to include all available destination waypoints which can be provided by the reservation system 100.

Destination information must be translated into waypoint data recognizable by a GPS unit. A waypoint is a location on a map, usually expressed in terms of Cartesian coordinates, i.e., latitude and longitude degrees (further broken down into arc minutes and seconds), which translates an address or other destination information into a precise and unique location on the Earth. The waypoint allows the GPS navigational system to calculate appropriate directions from a current or other location to the destination via available highways, roads and streets. It also enables a current (and interactive) “map” to be produced correlating a current GPS position to the underlying map data.

The traveler's destination data 108 may be translated or converted into waypoint data by the waypoint conversion module 110 in the reservation system 100 (step 208A) prior to being transmitted to the rental car company system 120 (step 210A) or by the waypoint conversion module 130 in the rental car company system 120 (step 208B) following receipt of the destination data 128 (step 210A). Then, prior to the traveler arriving to pick up the rental car, the rental car system 120 downloads the waypoint data into an on-board GPS unit 40 in a car 50 assigned to the traveler (step 212). It will be appreciated that other methods may be used to convert travel information into downloadable GPS waypoints. It will also be appreciated that the destination data itself may comprise downloadable GPS waypoints, thereby bypassing the need for steps 208A/B and 210A/B.

Upon arriving at the car pickup location, the traveler finds his or her car 50 and, upon entering that car 50, finds the appropriate waypoints for his or her trip pre-loaded into the on-board GPS unit 40. In addition, if the waypoints indicate that additional maps will be required, the traveler will find that the rental car company has preloaded the vehicle with all such maps that will be required. The rental car company may also provide printed directions to complement the GPS unit waypoints. Thus, the traveler can proceed directly to his or her hotel or other destination, without stopping to program the GPS unit 40, by following directions provided by the GPS unit 40, and without requiring additional maps or printed directions.

In addition to transmitting information about the traveler's reserved hotel to the rental car system 120, the reservation system 100 may also allow the traveler to indicate other destinations as part of the itinerary for transmission to the rental car system 120 and downloading into the GPS unit 40. Thus, for example, the traveler may enter the name or address of a customer with whom the traveler will be meeting as well as the name or address of a restaurant at which the traveler will have dinner. The reservation system 100 may also include a function which allows the traveler to search for and select a restaurant of a particular type that is nearest to the hotel. It will be appreciated that destinations of any type may be entered, not just those described as examples herein. Data for the additional destinations is transmitted to the rental car system along with the destination data 108 related to the air, car and hotel reservations. Furthermore, appropriate log-in information may allow the traveler to later log into the reservation system 100 before the trip in order to add additional destinations or change existing destinations. Data for these additional or changed destinations is transmitted to the rental car system 120 in the same manner as the initial destination data 108, or in a different manner if the car company or other service provider provides an alternative interface. During the trip, when the traveler leaves his or her hotel or other location, the GPS unit 40 will guide the traveler to the meeting location, restaurant or whatever other destination had been selected.

The GPS system will be preferentially programmed to have the first destination(s) at the top of the list. In the current Hertz “NeverLost”® System, a current traveler may occupy a vehicle and bring up a list of the last (n) destinations, for example the last five destinations. Instead, through use of the present invention, the destinations of a previous traveler will be cleared from the GPS system and the GPS system will display the next (n) destinations in the correct order for the traveler, for example, tonight's hotel, tonight's restaurant, tomorrow's customer site, tomorrow's hotel and the airport to which the automobile will be returned.

The travel reservation system of the present invention preferably allows individuals concerned about privacy to block the transmission of any or all of the destination data 108 to the rental car company system 120. Thus, if for any reason a traveler would feel more comfortable not communicating hotel information to the car company, that can be accomplished via user preferences. Similarly, if the traveler is going to a sensitive business meeting, such as to discuss a company merger or acquisition, the traveler can indicate that no destination data 108 is to be transmitted to the rental car system 120.

The interface may also provide the traveler with the option to request that the rental car company print 60 maps 70 of any of the destinations, with or without detailed driving directions. The maps 70 may be provided either in the rental car or at the check-in desk of the rental car company.

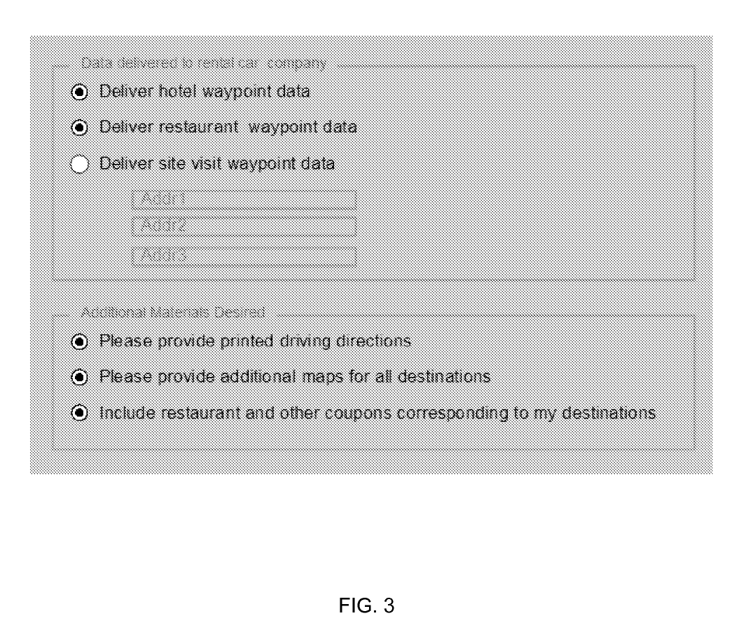

An example of such an interface is illustrated in FIG. 3 and shows how the traveler remains in control of which waypoint data and additional material would be appropriate for a particular trip.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies regardless of the particular type of signal bearing media actually used to carry out the distribution. Examples of computer readable storage media include recordable-type media such as a floppy disk, a hard disk drive, a RAM, and CD-ROMs.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. Thus, while the present invention has been discussed in terms of use with rental car companies and using onboard GPS systems, it will be appreciated that use of the present invention may be applied to other methods of transportation and contexts. For example, the present invention may include the identifying train stop for a particular hotel or provision of information to other transportation providers (limo, taxi, etc.) or to a party designated to meet the traveler at the correct hotel. Moreover, although described above with respect to methods and systems, the need in the art may also be met with a computer program product containing instructions for delivering waypoint data associated with a travel reservation.

What is claimed is:

1. A method for delivering waypoint data associated with a travel reservation, comprising:
receiving a travel itinerary for a traveler, including at least a first destination at which the traveler will rent a car from a rental car company and a second destination to which the traveler will drive the car; and
transmitting information about the first and second destinations to the rental car company for downloading into a GPS receiver in the rental car.

2. The method of claim 1:
further comprising converting the first and second destinations into GPS waypoint data; and
wherein transmitting information to the rental car company comprises transmitting the GPS waypoint data to the rental car company.

3. The method of claim 1, further comprising transmitting to the rental car company a request to provide the traveler with a printed map and directions from the first destination to the second destination when the traveler arrives at the first destination.

4. The method of claim 1, wherein the travel itinerary received for the traveler further includes a third destination to which the traveler will drive the car.

5. The method of claim 4, further comprising allowing the traveler to block the transmission of information about the third destination to the rental car company.

6. A method for delivering waypoint data associated with a travel reservation:
receiving a travel itinerary for a traveler, including at least a first destination and a second destination to which the traveler will travel using a transportation provider; and
transmitting information about the first and second destinations to the transportation provider.

7. The method of claim 6, further comprising converting the first and second destinations into the GPS waypoint data.

8. The method of claim 6, further comprising receiving the GPS waypoint data with the travel itinerary.

9. The method of claim 6, wherein the travel itinerary received for the traveler further includes a third destination to which the traveler will travel.

10. The method of claim 9, further comprising allowing the traveler to block the transmission of information about the third destination to the transportation provider.

11. A travel reservation system, comprising:
a first interface for receiving travel information from a traveler, the travel information comprising at least a first destination at which the traveler will rent a car from a rental car company and a second destination to which the traveler will drive the car; and
a second interface for transmitting information about the first and second destinations to the rental car company for downloading into a GPS receiver in the rental car.

12. The system of claim 11, further comprising a conversion module for converting the information about the first and second destinations into GPS waypoint data, wherein transmitting the information about the first and second destinations to the rental car company comprises transmitting the GPS waypoint data to the rental car company.

13. The system of claim 11, wherein the travel itinerary received for the traveler further includes a third destination to which the traveler will drive the car.

14. The system of claim 13, wherein the first interface is operable to receive a request from the traveler to not transmit the information about the third destination to the rental car company.

15. A computer program product of a computer readable medium usable with a programmable computer, the computer program product having computer-readable code embodied therein for delivering waypoint data associated with a travel reservation, the computer-readable code comprising instructions for:
receiving a travel itinerary for a traveler, including at least a first destination at which the traveler will rent a car from a rental car company and a second destination to which the traveler will drive the car; and
transmitting information about the first and second destinations to the rental car company for downloading into a GPS receiver in the rental car.

16. The computer program product of claim 15, wherein:
the instructions further comprise instructions for converting the first and second destinations into GPS waypoint data; and
transmitting information to the rental car company comprises transmitting the GPS waypoint data to the rental car company.

17. The computer program product of claim 15, the instructions further comprising instructions for transmitting to the rental car company a request to provide the traveler with a printed map and directions from the first destination to the second destination when the traveler arrives at the first destination.

18. The method of claim 15, wherein the travel itinerary received for the traveler further includes a third destination to which the traveler will drive the car.

19. The computer program product of claim 18, the instructions further comprising instructions for allowing the traveler to block the transmission of information about the third destination to the rental car company.
